(19) United States
(12) Patent Application Publication
(10) Pub. No.: US 2015/0189482 A1
(43) Pub. Date: Jul. 2, 2015

(54) DEVICE FOR PROVIDING RELATED INFORMATION FOR MONILE COMMUNICATION TERMINAL AND SYSTEM FOR SHARING RELATED INFORMATION

(71) Applicant: AND WORKS CO., LTD., Seoul (KR)

(72) Inventor: Jung-Moon Yang, Seoul (KR)

(73) Assignee: AND WORKS CO., LTD., Seoul (KR)

(21) Appl. No.: 14/406,573

(22) PCT Filed: Apr. 22, 2013
(86) PCT No.: PCT/KR2013/003396

§ 371 Date: Dec. 9, 2014

(30) Foreign Application Priority Data
Jun. 12, 2012 (KR) 10-2012-0062513
Jun. 28, 2012 (KR) 10-2012-0069775
Sep. 25, 2012 (KR) 10-2012-0106509

(51) Int. Cl. H04W 4/12; G06F 17/22; G06F 17/30

(52) U.S. Cl. CPC H04W 4/12; G06F 17/30864; G06F 17/2235

(57) ABSTRACT

A mobile communication terminal includes: a word storage unit that stores a word registered by a user; a related information storage unit that stores related information corresponding to the word registered in the word storage unit; a related information linking unit that, when the word stored in the word storage unit is input upon creation of the text, hyperlinks related information corresponding to the input word; and a text transmitting unit that transmits the text, in which related information is hyperlinked to at least one word by the related information linking unit, through a network. According to the present invention, the user can provide pieces of various related information with respect to a created document without generating hyperlinks separately by using an automatic hyperlink function every time when the user creates a document using a mobile communication terminal, such as a mobile phone or a smartphone.

### TECHNICAL FIELD

The present invention relates to a related information providing apparatus and a related information sharing system, and more particularly, to a related information providing apparatus and a related information sharing system for mobile communication terminals, which allow a user to add related information to a message to be transmitted to another person and provide the related information by using a mobile communication terminal, such as a mobile phone or smartphone, thereby sufficiently transferring desired information through a minimum number of character inputs.

### BACKGROUND ART

In General, a hyperlink has been widely used since the hyperlink achieves convenience in searching using Internet and conciseness in document creation. The hyperlink refers to linking of an element within a hypertext document, such as one word, a phrase, a symbol, or an image, to another element as related information when a user creates the document. The hyperlink reduces a need to repeatedly input a pre-created document whenever the user creates the document, and allows the receiver to easily acquire information necessary by easily clicking a hyperlinked portion if necessary.

Such a hyperlink makes a user feel inconvenience since the user separately sets links to a word, a phrase, a symbol or the like which hyperlinks need to be set every time when the user creates a document.

On the other hand, with the development of communication technology, a user can create a document and transmit the document to another communication terminal by using the user's terminal even during movement. The mobile communication terminal, such as a mobile phone or a smartphone, allows the user to transfer information during movement at any time and anywhere. However, since it is necessary to minimize data to be transmitted and received during movement, there is a limit in the number of characters to be transmitted, compared to a wired communication terminal.

### DISCLOSURE

### Technical Problem

Embodiments of the present invention are directed to a related information providing apparatus and a related information sharing system, capable of providing pieces of various related information with respect to a created document without generating hyperlinks separately every time when the user creates a document using a mobile communication terminal, such as a mobile phone or a smartphone, thereby sufficiently transferring desired information through a minimum number of character inputs.

### Technical Solution

According to an aspect of the present invention, a related information providing apparatus for mobile communication terminals, the related information providing apparatus including related information in a text transmitted and received through a network to provide the related information, the related information providing apparatus includes: a related information storage unit that stores a word set by a subscriber and related information corresponding to the word; a word searching unit that searches for the word stored in the related information storage unit from a text created by a mobile communication terminal connected to the related information providing apparatus through the network; a related information linking unit that hyperlinks the related information stored in the related information storage unit to the word found by the word searching unit; and a text transmitting unit that transmits the text to which the related information is hyperlinked by the related information linking unit, to the receiver terminal.

The related information providing apparatus may further includes a subscriber information storage unit that stores subscriber information including at least one of a name, an identification (ID), an email address, and a terminal identification number of the subscriber. The mobile communication terminal may be a terminal of a subscriber of which subscriber information is stored in the subscriber information storage unit.

The related information providing apparatus may further include: a selection signal receiving unit that receives a selection signal for the word which is hyperlinked by the related information linking unit, from the receiver terminal; and a related information transmitting unit that transmits the related information stored in the related information storage unit to the receiver terminal corresponding to the selection signal received by the selection signal receiving unit.

The related information transmitting unit may transmit a selection menu for selecting a detailed item included in the related information of the hyperlinked word to the receiver terminal.

The related information providing apparatus may further include a history storage unit that stores history information including transmission records of the hyperlinked word in the text transmitted to the receiver terminal by the text transmitting unit. The related information transmitting unit may transmit the history information to at least one of the mobile communication terminal and the receiver terminal.

The related information providing apparatus may further include a receiver information storage unit that stores receiver information including at least one of a name, an identification (ID), an email address, and a terminal identification number of a receiver.

The related information linking unit may hyperlink relevant related information to a word searched by the word searching unit when the receiver terminal is a receiver terminal of a receiver stored in the receiver information storage unit.

When two or more pieces of related information are searched with respect to the same word, the related information linking unit may hyperlink relevant information corresponding to a location of the receiver terminal.

When an instruction for retransmitting the text received by the receiver terminal to a third party terminal is received from the receiver terminal, the text transmitting unit may retransmit a text that is hyperlinked similarly as the text transmitted to the receiver terminal, to the third party terminal.

The related information providing apparatus may further include a receiver information storage unit that stores receiver information including at least one of a name, an identification (ID), an email address, and a terminal identification number of a receiver. The related information storage unit may store related information corresponding to a receiver stored in the receiver information storage unit.

According to another aspect of the present invention, a related information system for mobile communication terminals, includes: a mobile communication terminal that creates a text, stores related information for at least one in the text, hyperlinks the related information to the word, and transmits the text including the hyperlinked word through a network; a receiver terminal that receives the text from the mobile communication terminal; and a related information sharing server that stores related information that is set to be shared from among the related information stored in the mobile communication terminal and, when a request for receiving the related information set to be shared is provided from the mobile communication terminal, transmits the related information to the mobile communication terminal.

According to another aspect of the present invention, a mobile communication terminal which creates a text and transmits the created text through a network, includes: a word storage unit that stores a word registered by a user; a related information storage unit that stores related information corresponding to the word registered in the word storage unit; a related information linking unit that, when the word stored in the word storage unit is input upon creation of the text, hyperlinks related information corresponding to the input word; and a text transmitting unit that transmits the text, in which related information is hyperlinked to at least one word by the related information linking unit, through a network.

The mobile communication terminal may further include a hyperlink selecting unit that, when the word stored in the word storage unit upon creation of the text, selecting whether to set a hyperlink of the related information corresponding to the input word. The related information linking unit may hyperlink relevant related information when the hyperlink is selected by the hyperlink selecting unit.

The mobile communication terminal may further include a sharing setting unit that sets whether to share the related information stored in the related information storage unit and uploads the related information set to be shared to a related information sharing server through a network.

The mobile communication terminal may further include a history information storage unit that stores history information including at least one of a transmission target, a transmission time, a hyperlinked word, and information on whether the related information, corresponding to the text transmitted to the network by the text transmitting unit.

The mobile communication terminal may further include a location query unit that queries for a location of a transmission target when two or more pieces of related information are searched from the related information storage unit corresponding to a selection by the hyperlink selection unit. The related information linking unit may hyperlink related information corresponding to the location queried by the location query unit.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

According to the present invention, the user can provide pieces of various related information with respect to a created document without generating hyperlinks separately every time when the user creates a document using a mobile communication terminal, such as a mobile phone or a smartphone. Therefore, it is possible to sufficiently transfer desired information through a minimum number of character inputs.

### BRIEF DESCRIPTION OF THE DRAWINGS

FIG. 1 is a diagram explaining a concept of a related information providing apparatus according to a first embodiment of the present invention.

FIG. 2 is a diagram schematically illustrating a configuration of the related information providing apparatus according to the first embodiment of the present invention.

FIG. 3 is a diagram illustrating an example of hyperlinked text displayed by the related information providing apparatus according to the first embodiment of the present invention.

FIG. 4 is a diagram illustrating an example of a selection menu for a hyperlinked word.

FIG. 5 is a diagram illustrating an example in related information is transmitted according to the selection menu illustrated in FIG. 4.

FIG. 6 is a diagram illustrating an example for displaying a text transmission time and information on whether selection is made.

FIG. 7 is a diagram illustrating an example for displaying a selection method.

FIG. 8 is a flowchart illustrating a related information providing method according to an embodiment of the present invention.

FIG. 9 is a diagram schematically illustrating a related information sharing system according to a second embodiment of the present invention.

FIG. 10 is a diagram schematically illustrating a configuration of a mobile communication terminal according to a second embodiment of the present invention.

FIG. 11 is a diagram illustrating an example in which a user manages related information by using an application installed in a mobile communication terminal.

FIG. 12 is a diagram illustrating an example of a method of arranging linked words which are executed through an application.

FIG. 13 is a flowchart illustrating a text transmission method of the mobile communication terminal according to the second embodiment of the present invention.

### BEST MODE FOR THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, a related information providing apparatus and a related information providing method according to embodiments of the present invention, will be described in detail with reference to the accompanying drawings.

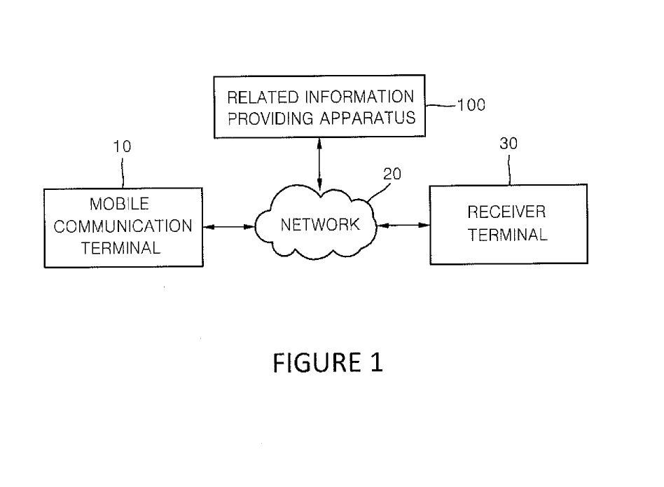

FIGS. 1 to 8 are diagrams illustrating a first embodiment of the present invention.

FIG. 1 is a diagram explaining a concept of a related information providing apparatus according to a first embodiment of the present invention. Referring to FIG. 1, a mobile communication terminal 210 may transmit a short message service (SMS) message, text, or the like to a receiver terminal 30 through a network 20. The mobile communication terminal 210 includes all types of terminals, such as a mobile phone or a smartphone, capable of allowing for creation of a SMS message, text, or the like during movement, and transmitting the created SMS message, text, or the like to another communication terminal through the network 20.

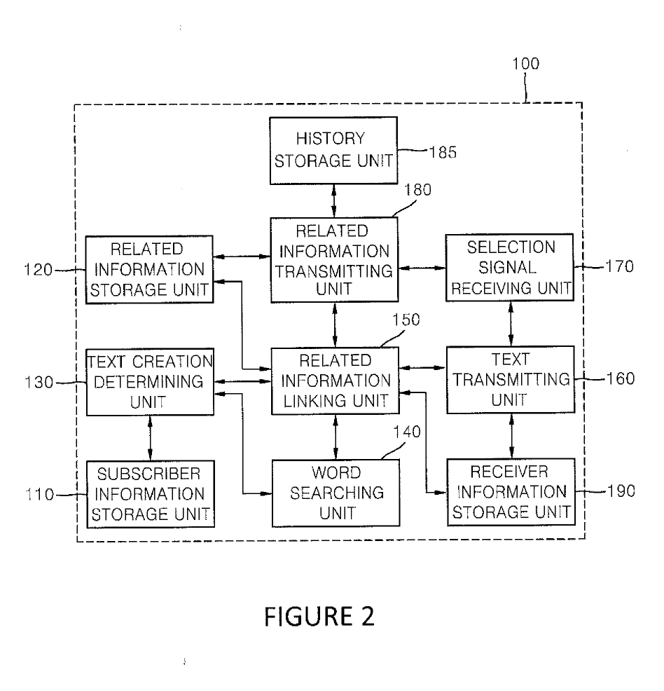

FIG. 2 is a diagram schematically illustrating a configuration of the apparatus for providing related information according to the first embodiment of the present invention.

Referring to FIG. 2, the related information providing apparatus 100 according to the present invention may include a subscriber information storage unit 110, a related information storage unit 120, a text creation determining unit 130, a word searching unit 140, a related information linking unit 150, a text transmitting unit 160, a selection signal receiving unit 170, a related information transmitting unit 180, a history storage unit 185, and a receiver information storage unit 190.

The subscriber information storage unit 110 stores subscriber information including at least one of a subscriber name, an identification (ID), an email address, and a terminal identification number. The subscriber information storage unit 110 authenticates information registered when the subscriber subscribes to a related information providing service according to the present invention, and stores the authenticated subscriber information.

The related information storage unit 120 matches a word set by the subscriber to related information corresponding to the word and stores the related information. The related information is additional information which the subscriber wants to transfer to another person corresponding to the word set by the subscriber. The related information may be uniform resource locator (URL) information of a web page in which a document, an image, a moving image, or the like, which is created by the subscriber or another person, is stored. Alternatively, the related information may be the document, the image, or the moving image itself, which is created by the subscriber, or may be directory information indicating a file location at which the document, the image, the moving image, or the like is stored.

In this case, the related information storage unit 120 may match the same word to a plurality of pieces of related information which are set according to various conditions and stores the plurality of pieces of related information. For example, the related information storage unit 120 may match and store different pieces institute information to a word “learning” according to the regions of addresses. Alternatively, the related information storage unit 120 may match and store different pieces institute information according to age groups, such as 10s, 20, 30s, or the like, even in the same region.

The text creation determining unit 130 determines whether a text is created by the mobile communication terminal 10 when the mobile communication terminal 10 is connected to the apparatus for providing related information through the network 20. In this case, the mobile communication terminal 10 may be a terminal of a subscriber corresponding to subscriber information stored in the subscriber information storage unit 110. That is, when the mobile communication terminal 10 is authenticated based on the subscriber information stored in the subscriber information storage unit 110, the text creation determining unit 130 determines whether a text is created by the mobile communication terminal 10 by determining whether a text input signal is provided from the mobile communication terminal 10. Even when the mobile communication terminal 10 is a terminal owned by a third party which is not a subscriber, the text creation determining unit 130 may determine whether a text is created by the mobile communication terminal 10.

When the text creation determining unit 130 determines that a text is created in the mobile communication terminal 10, the word searching unit 140 searches for a word identical to a word stored in the related information storage unit 120 from the text created by the mobile communication terminal 10.

The related information like unit 150 extracts related information stored in the related information storage unit 120 and hyperlinks the extracted related information to the word searched by the word searching unit 140. When a plurality of pieces of information are present in the related information storage unit 120 corresponding to a single word, the related information linking unit 150 may select any one of the plurality of pieces of related information according to a user selection and transmit the selected related information to the related information linking unit 150.

In this case, the related information linking unit 150 may query whether to set a hyperlink for the word searched by the word searching unit 140 of the mobile communication terminal 10, and when an acceptance signal is transmitted from the mobile communication terminal 10, may hyperlink the related information stored in the related information storage unit 120 to the word.

The text transmitting unit 160 transmits the text in which the related information is hyperlinked by the related information linking unit 150 to the receiver terminal 30 through the network 20.

On the other hand, when the receiver terminal 30 wants to re-transmit the text received from the mobile communication terminal 10 to a third party terminal (not illustrated), the receiver terminal 30 transmits an instruction for retransmitting the text to the third party terminal to the related information providing apparatus 100. Therefore, the text transmitting unit 160 of the related information providing apparatus 100 transmits the text in which the related information is hyperlinked similarly as the text received by the receiver terminal 30, to the third party terminal. Therefore, a user of the third party terminal can receive information related to the created text although the user is not an original receiver of the text created in the mobile communication terminal 10. In this case, the related information providing apparatus 100 may query for whether to transmit and receive the related information with respect to the receiver terminal 30 or the third party terminal. According to a response signal corresponding to the query, whether to set a hyperlink of the related information for the retransmitted text may be determined.

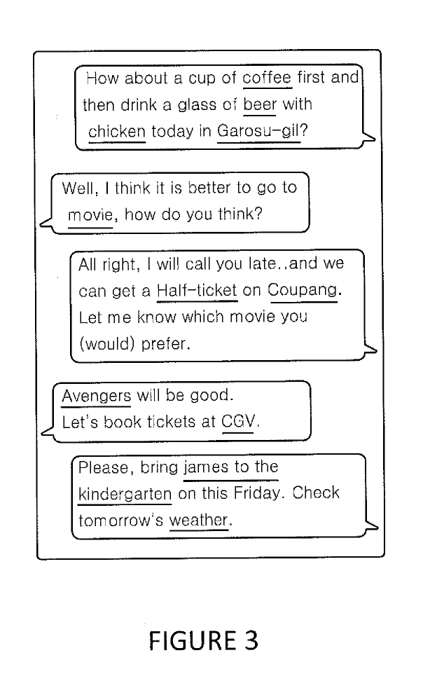

FIG. 3 is a diagram illustrating an example of hyperlinked text displayed by the related information providing apparatus according to the first embodiment of the present invention, that is, an example in which a hyperlink is displayed on dialogue context transmitted and received between the mobile communication terminal 10 and the receiver terminal 30. That is, when a subscriber sets words, such as, Garosu-gil, coffee, chicken, Coupang, Half-thicket, James kindergarten, and weather, and sets and stores respective pieces of related information respectively corresponding to the words, the related information linking unit 150 hyperlinks the pieces of related information to the words respectively and transmits a text in which pieces of related information are hyperlinked to words of the text to the receiver terminal 30.

As described above, the related information storing unit 120 may store a plurality of pieces of related information corresponding to the same word according to additional conditions, such as the location or age of a receiver. In this case, the related information storing unit 120 may hyperlink the plurality of pieces of related information to a relevant word. For example, when the related information storage unit 120 stores a word “movie” set by the subscriber, classifies current movies into several types which people can watch according to their age groups, and stores information on the current movies as related information, the related information linking unit 150 may hyperlink all or any one of a plurality of pieces of movie information which are classified according to the people's age groups to the word “movie”. Also, when the related information storage unit 120 sets and stores a word (CGV in FIG. 2) indicating a specific theater by the subscriber, and sets and stores information on affiliated theaters in each region corresponding thereto, as related information, the related information linking unit 150 may hyperlink a plurality of pieces of affiliated theater information in each region to the specific theater.

The selection signal receiving unit 170 receives a selection signal for selecting a hyperlinked word from the receiver terminal 30 which receives the text transmitted by the text transmitting unit 160. For example, when “Garosu-gil” is selected by the receiver terminal 30 from among the words, such as “Garosu-gil, coffee, chicken, and beer” which are selected and hyperlinked by the subscriber in FIG. 3, the selection signal receiving unit 170 receives a selection signal corresponding to the word “Garosu-gil” selected by the receiver terminal 30.

The related information transmitting unit 180 searches for related information stored in the related information storage unit 120 in response to the selection signal received by the selection signal receiving unit 170, extracts the searched related information, and transmits the searched related information to the receiver terminal 30.

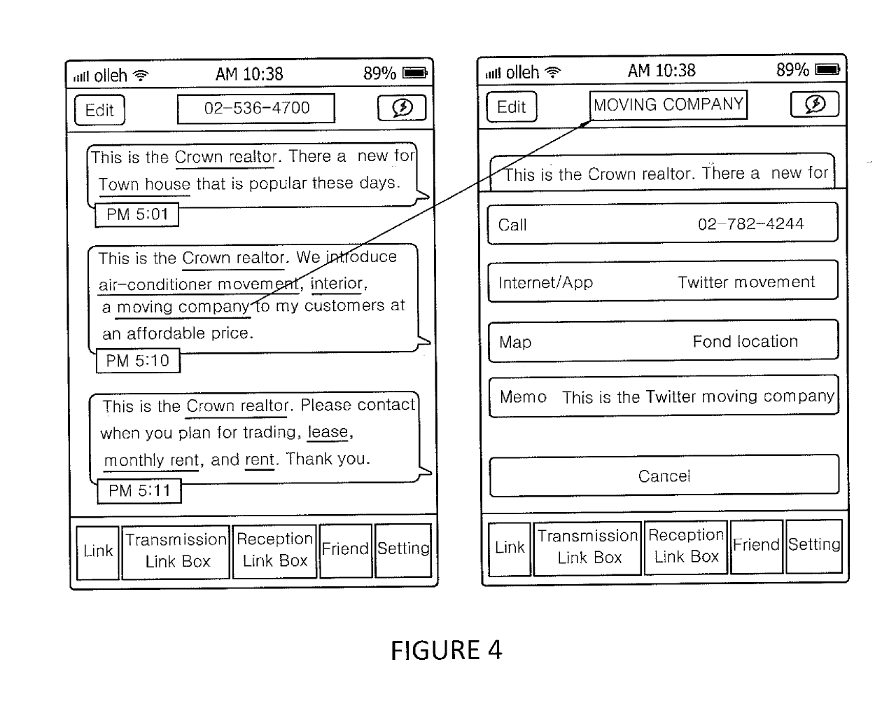

In this case, the related information transmitting unit 180 may provide selection menus for selecting detailed items included in related information of respective hyperlinked words displayed on the receiver terminal 30. For example, as illustrated in FIG. 4, when hyperlinked words, such as Crown realtor, air-conditioner movement, interior, moving company, are displayed on the receiver terminal 30, selections, such as call, Internet/App, map and memo, may be provided as the selection menus corresponding to the word “moving company”. To this end, the related information storage unit 120 stores related information, such as phone number, Internet/App, map, and memo, as detailed items corresponding to the hyperlinked word “moving company”.

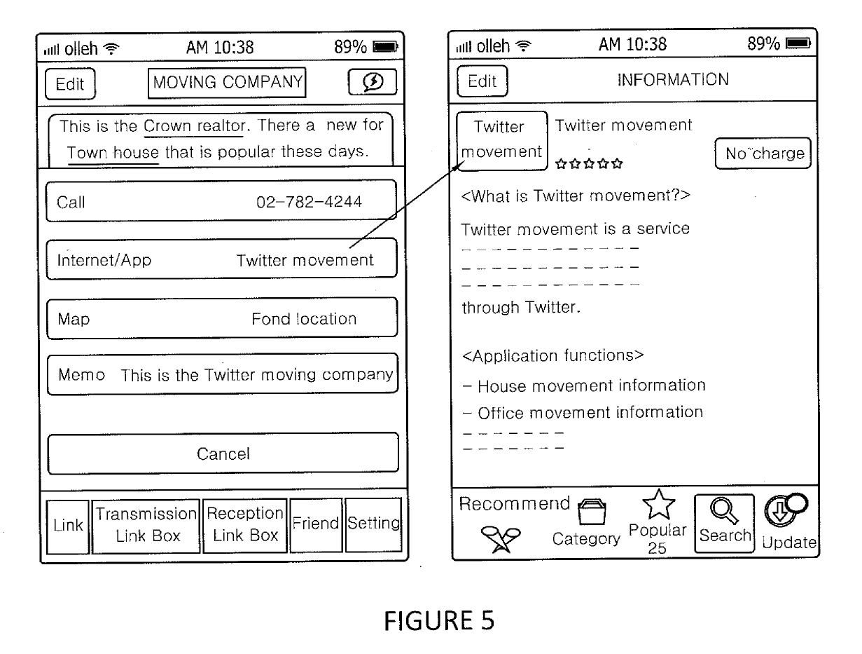

That is, when a plurality of detailed items are present in a single piece of related information, the related information transmitting unit 180 may transmit all or some of the plurality of pieces of related information or all or some of detailed items for any one piece of related information to the receiver terminal 30, based on the selection menus provided by the selection signal receiving unit 170 Thereafter, in a case where selection menus, such as call, Internet/App, map and memo, for a moving company named “Twitter movement” are displayed as selection menus corresponding to the word “moving company” as illustrated in FIG. 5, when the receiver selects a menu “Internet/App”, the related information transmitting unit 180 transmits the Internet web page of “Twitter movement” as related information to the receiver terminal 30.

In this case, when a location hyperlinked by the related information linking unit 150 is a specific folder in the mobile communication terminal 10, the related information transmitting unit 180 extracts a designated file in the folder at the location and transmits the file to the receiver terminal 30.

On the other hand, when a plurality of hyperlinks is set to the same word by the related information linking unit 150, partial related information selected from among a plurality of pieces of related information may be transmitted to the receiver terminal 30 based on at least one of pieces of various additional information, such as location information of the receiver terminal 30, age of a receiver corresponding to the receiver terminal 30, and the like. For example, when a plurality of pieces of related information which are classified in people's age groups are hyperlinked corresponding to the word “movie” set by the subscriber, the related information transmitting unit 180 may select related information according to the age of the receiver corresponding to the receiver terminal 30 and transmits the related information to the receiver terminal 30. When a plurality of affiliated theaters are linked as related information corresponding to the word “GCV” set by the subscriber, it is possible to query for location information of the receiver terminal 30, select related information about a theater closest to the receiver terminal 30 from among the plurality of affiliated theaters, and transmit related information to the receiver terminal 30.

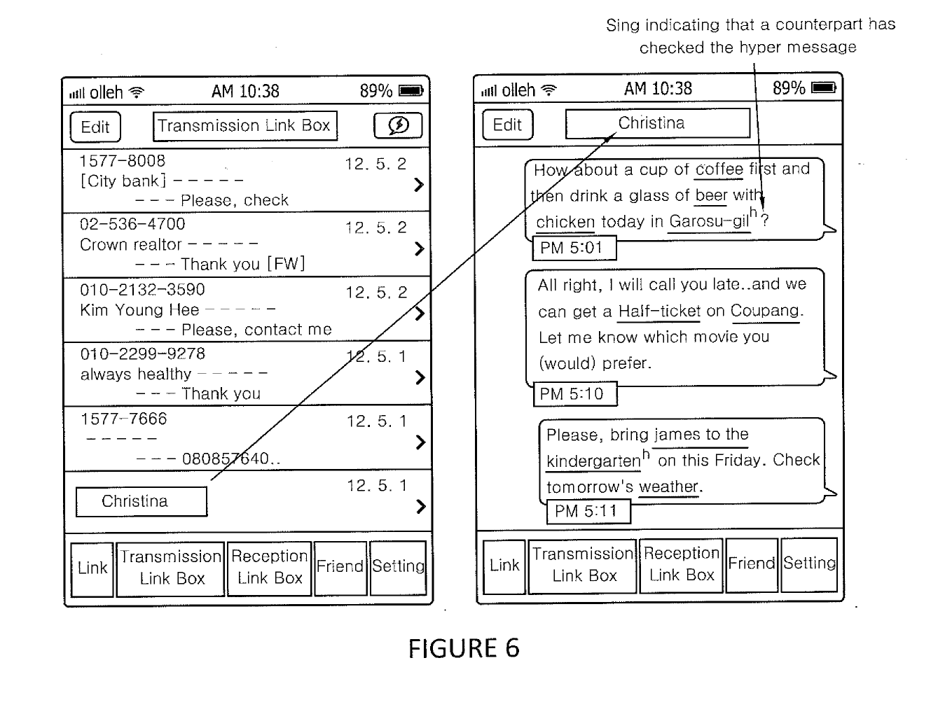

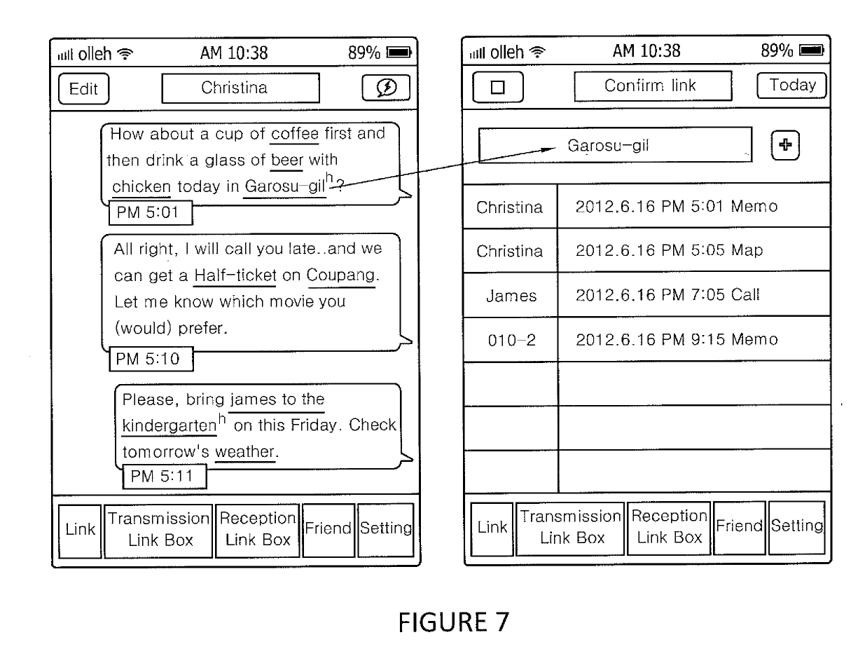

The history storage unit 185 may store history information that is transmission records of related information transmitted to the receiver terminal 30. In this case, the history storage unit 185 may store, as the history information, at least one of a transmission time at which the text is transmitted to the receiver terminal 30, information on whether a hyperlinked word is selected, a selection time at which the hyperlinked word is selected, and a selection method of selecting the hyperlinked word. In this case, the related information transmitting unit 180 may provide the history information stored in the history storage unit 185 to at least one of the mobile communication terminal 10 and the receiver terminal 30. For example, when the mobile terminal 10 transmits hyperlinked texts to several receivers as illustrated in FIG. 6, it is possible to display transmission times of the respective texts and information on whether the receiver selects respective hyperlinked words on the mobile communication terminal 10. When any one of the receivers is selected, a record of text transmission and reception to the selected receiver is displayed on the mobile communication terminal 10. Also, as illustrated in FIG. 7, it is possible to display a time at which the hyperlinked word in the text is selected by the receiver terminal 30, a selection method of selecting the word, and the like. As illustrated in FIG. 7, when a user of the mobile communication terminal 10 selects “Garosu-gil”, a history of the word “Garosu-gil” including information on who select the word “Garosu-gil” and query related information, when the word “Garosu-gil” is selected, and which detailed items is selected. In FIG. 7, there is illustrated a case in which the hyperlinked word “Garosu-gil” is selected four times in the order of memo ->map ->telephone ->memo. Although transmission records are described as being transmitted to the mobile communication terminal 10 therein, the transmission records may be transmitted to the receiver terminal 30.

The receiver information storage unit 190 stores receiver information including at least one of a name of a receiver, an ID, an email address, and a terminal identification number, which are set by a subscriber. For example, the subscriber may select a specific acquaintance from among acquaintances stored in an address book of the subscriber's mobile communication terminal 10 and store receiver information including at least one of a name, an ID, an email address, and a terminal identification number corresponding to the specific acquaintance, in the receiver information storage unit 190. In this case, the related information linking unit 150 may be implemented to hyperlink a word searched by the word searching unit 140 to related information corresponding thereto only when the receiver terminal 30 is the terminal of a receiver stored in the receiver information storage unit 190. Also, the related information storage unit 129 may store pieces of different related information corresponding to the same word according to receivers stored in the receiver information storage unit 190.

When two or more pieces of related information are searched with respect to the same word, it is preferable that the related information linking unit 150 preferentially hyperlink related information corresponding to the receiver stored in the receiver information storage unit 190. That is, when a plurality of pieces of related information are searched with respect to the same word, the related information linking unit 150 preferentially hyperlink related information which is set to correspond to the word based on information of the receiver terminal 30.

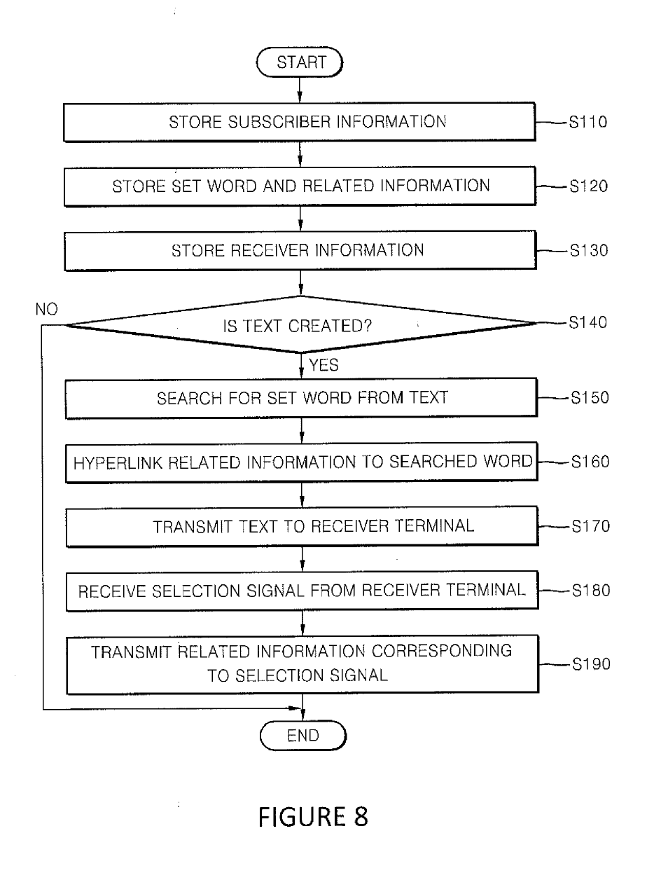

FIG. 8 is a flowchart illustrating a related information providing method according to an embodiment of the present invention.

Referring to FIG. 8, the subscriber information storage unit 110 stores subscriber information including at least one of a subscriber name, an identification (ID), an email address, and a terminal identification number (S110).

The related information storage unit 120 matches a word set by the subscriber to related information corresponding to the word and stores the related information (S120). In this case, the related information storage unit 120 matches a plurality of pieces of different related information to the same word according to various additional conditions, such as the location or age of the receiver.

The receiver information storage unit 190 may store receiver information including at least one of a name of a receiver, an ID, an email address, and a terminal identification number which are set by a subscriber (S130). In this case, the related information storage unit 129 may store pieces of different related information corresponding to the same word according to receivers stored in the receiver information storage unit 190.

The text creation determining unit 130 determines whether a text is created by the mobile communication terminal 10 when the mobile communication terminal 10 is connected to the apparatus for providing related information through the network 20 (S140). The text creation determining unit 130 may determine whether the subscriber's terminal is connected thereto or whether a third party terminal is connected thereto, through the network 20 based on subscriber information stored in the subscriber information storage unit 110. When it is determined that the mobile communication terminal 10 is connected, determination is performed as to whether a text is created in the mobile communication terminal 10 by determining whether a text input signal is received from the mobile communication terminal 10.

When the text creation determining unit 130 determines that a text is being created in the mobile communication terminal 10, the word searching unit 140 searches for a word identical to a word stored in the related information storage unit 120 from the text created by the mobile communication terminal 10 (S150).

The related information linking unit 150 hyperlinks related information stored in the related information storage unit 120 to the word searched by the word searching unit 140 (S160). In this case, when the related information storage unit 120 stores a plurality of pieces of information corresponding to the same word according to location information, age groups or the like, the related information linking unit 150 may hyperlink the plurality of pieces of information to the word. Also, when the receiver terminal 30 to which the text created by the mobile communication terminal 10 is to be transmitted is a receiver terminal corresponding to the receiver information stored in the receiver information storage unit 190, the related information linking unit 150 may be implemented to hyperlink related information corresponding to the word searched by the word searching unit 140 to the word. When two or more pieces of related information are searched from the related information storage unit 120 corresponding to the same word, the related information storage unit 150 may query a location of the receiver terminal 30 and hyperlink related information corresponding to a location closest to the receiver among pieces of searched related information, according to an acquired location.

The text transmitting unit 160 transmits the text in which the related information is hyperlinked by the related information linking unit 150 to the receiver terminal 30 through the network 20 (S170).

The selection signal receiving unit 170 receives a selection signal corresponding to the word hyperlinked by the related information linking unit 150 from the receiver terminal 30. In this case, the related information transmitting unit 170 may provide selection menus for details of related information of respective hyperlinked words displayed on the receiver terminal 30.

The related information transmitting unit 180 searches for related information stored in the related information storage unit 120 corresponding to the selection signal received by the selection signal receiving unit 170, extracts the searched related information, and transmits the searched related information to the receiver terminal 30 (S190).

When there are a plurality of pieces of related information with respect to one word or a plurality of detailed items with respect to one pieces of related information, the related information transmitting unit 180 transmits any one of the plurality of pieces of related information or any one of the plurality of detailed items of the related information to the receiver terminal 30 based on selection menus provided by the selection signal receiving unit 170.

The history storage unit 185 may store history information that is transmission records of a hyperlinked word corresponding to related information transmitted to the receiver terminal 30. In this case, the history storage unit 185 may store, as the history information, at least one of a transmission time at which the text is transmitted to the receiver terminal 30, information on whether a hyperlinked word is selected, a selection time at which the hyperlinked word is selected, and a method of selecting the hyperlinked word. In this case, the related information transmitting unit 180 may provide the history information stored in the history storage unit 185 to at least one of the mobile communication terminal 10 and the receiver terminal 30.

According to the embodiments of the present invention, when the mobile communication terminal transmits a SMS message, an email, or the like, related information previously set by the subscriber is automatically hyperlinked and transmitted to the receiver terminal, by merely creating a text. Therefore, the receiver can acquire the related information set by the subscriber without separate search.

Also, according to the present invention, the subscriber can select a reception target to which related information is to be transmitted and transmits a hyperlinked text, thereby preventing related information set by the subscriber to be transmitted indiscriminately.

Also, according to the present invention, the subscriber can set related information, such as information stored in the mobile communication terminal or information stored in a specific web site, differently according to reception targets, thereby setting and transmitting optimal related information according to reception targets.

Also, according to the present invention, the subscriber can classify and store pieces of related information for products or services which the subscriber himself or herself sells, according locations or age groups of customers, and transmit optimal advertisement information to the customers, thereby maximizing advertisement effects.

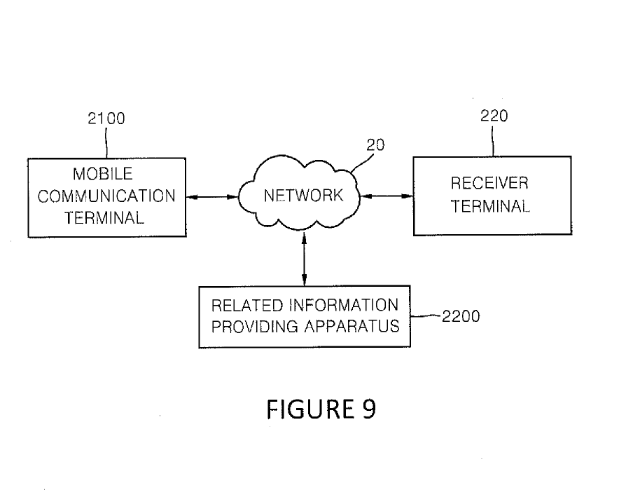

FIGS. 9 to 13 are diagrams illustrating a second embodiment of the present invention.

FIG. 9 is a diagram schematically illustrating a related information sharing system according to a second embodiment of the present invention. The related information sharing system includes a network 210, a receiver terminal 220, a mobile communication terminal 2100, and a related information sharing server 2200. In this case, the network 210 refers to a wide sense network including a third-generation mobile communication network, such as a code division multiple access (CDMA) network or a wideband CDMA (WCDMA) network, a wireless Internet network, such as a WiFi network or a wibro network, and a fourth-generation wireless Internet network, such as a long term evolution (LTE) network.

The receiver terminal 220 is a terminal as a reception target which receives a hyperlinked text through the network 210, and includes a terminal capable of transmitting and receiving data through a mobile communication network or a wireless Internet network.

The mobile communication terminal 2100 may transmit an SMS message and a text to the receiver terminal 220 through the network 220. The mobile communication terminal 2100 refers to a terminal, such as a mobile phone, a smartphone or a notebook, capable of allowing for creation of a SMS message, a text, or the like during movement, and transmitting the created SMS message, text, or the like to another communication terminal through the network 210. Also, a method of transmitting the SMS message or the text through the network 210, which is performed by the mobile communication terminal 2100, is not limited to a method of using a general SMS service and can be made according to various methods, such as a method of transmitting the message through a dedicated application, such as a messenger. In this case, the mobile communication terminal 2100 hyperlinks related information to an input specific word of the text upon creation of the SMS message or the text (hereinafter, collectively referred to as a “text”) such that a user of the receiver terminal 220 easily finds the related information corresponding to the specific word. The related information may include uniform resource locator (URL) information of a web page.

Also, the user of the mobile communication terminal 2100 may upload related information set by the user himself or herself to the related information sharing server 2200 to allow the related information to be shared with other mobile communication terminals and may revise the related information set by the user himself or herself based on related information shared by other terminals.

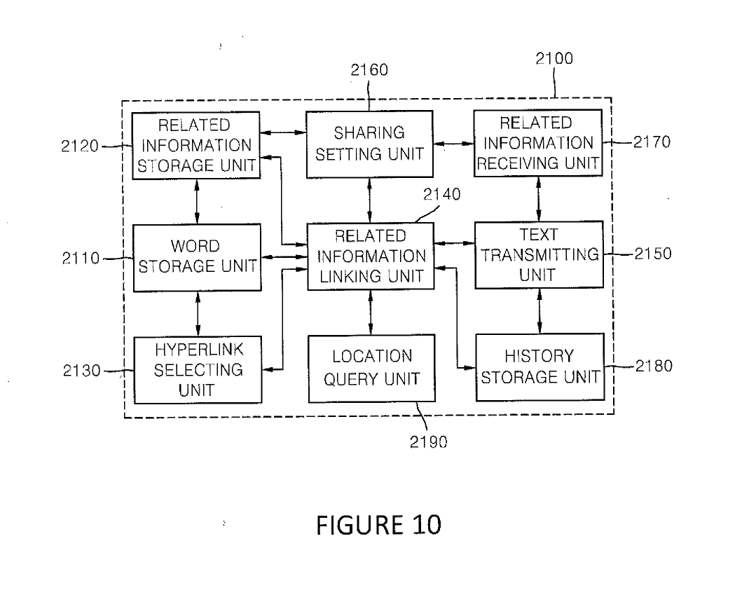

FIG. 10 is a diagram schematically illustrating a configuration of a mobile communication terminal according to a second embodiment of the present invention.

Referring to FIG. 10, the mobile communication terminal 2100 according to the present invention may includes a word storage unit 2110, a related information storage unit 2120, a hyperlink selecting unit 2130, a related information linking unit 2140, a text transmitting unit 2150, a sharing setting unit 2160, a related information receiving unit 2170, a history storage unit 2180, and a location query unit 2190. The functions of the respective components of the mobile communication terminal 2100 may be implemented by a hardware module mounted in the mobile communication terminal 2100, may be implemented through an application installed in the mobile communication terminal 2100, or may be implemented by interworking between the hardware module and the application.

The word storage unit 2100 stores a word registered by the user. That is, the word storage unit 2110 may designate and store a specific word which is wanted to be transmitted along with related information by the user when the user creates a text by using the user's mobile communication terminal 2100.

The related information storage unit 2120 stores related information corresponding to the word registered in the word storage unit 2110. In this case, the related information storage unit 2120 may match and store s a plurality of pieces of different related information to the same word according to the location, age, gender, or the like of a receiver to which the text is to be transmitted. For example, the related information storage unit 2120 may match and store pieces of different movie theater information to a word “movie” according to the location of a receiver to which the text is to be transmitted. Alternatively, the related information storage unit 2120 may match and store pieces of different movie information to location information according to age groups, such as 10s, 20s, 30s, or the like even in the same region.

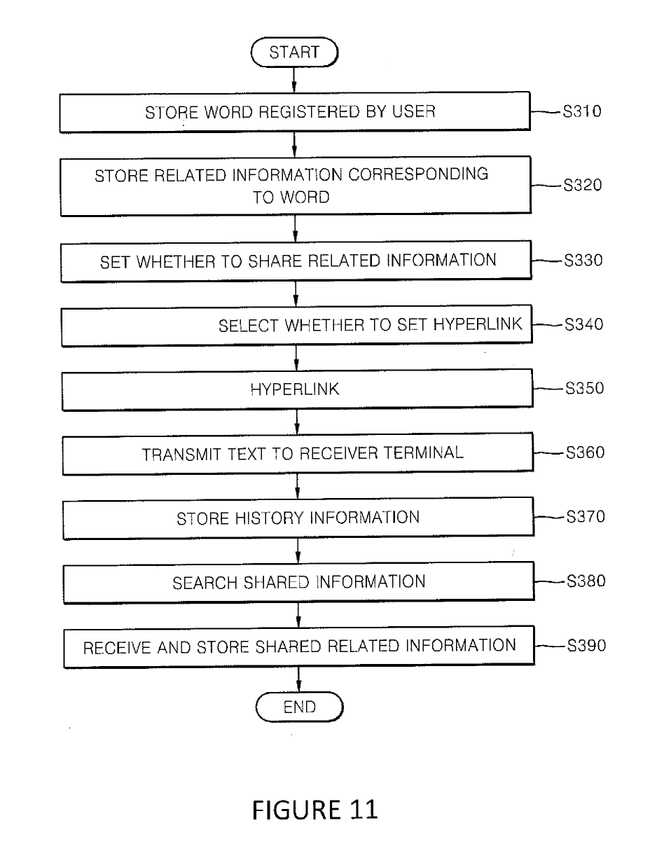

FIG. 11 illustrates an example in which a user manages related information by using an application installed in the mobile communication terminal 2100. That is, a user can operate an application installed in the mobile communication terminal 2100, store related information in the related information storage unit 2120, edit or delete the stored related information, and search for a specific related information from the stored related information.

The hyperlink selecting unit 2130 may select whether to set a hyperlink to a word registered in the word storage unit 2110. That is, when a word registered in the word storage unit 2110 is input upon creation of a text through the mobile communication terminal 2100, the hyperlink selecting unit 2130 may determine whether to set the hyperlink of related information corresponding to the input word according to a user selection. As one method for this end, a predetermined key (for example, “@”) that is previously defined is defined as a hyperlink setting command in advance and a hyperlink is set to a word which is input immediately after the predetermined key is input. For example, in a case where a user inputs the predetermined key @ and then inputs a word “school” when creating a text by using the mobile communication terminal 2100, when the word is a word that has been registered in the word storage unit 2110, related information stored corresponding to the word “school” is hyperlinked thereto.

On the other hand, the hyperlink selecting unit 2130 may provide a list of related words which are stored in the word storage unit 2110 according to the number of letters of an input word. For example, assuming that words “ACE”, “Application” and “April” are stored in the word storage unit 2110, when the user first inputs a letter “A”, “ACE”, “Application” and “April” of which the first letters are “A” may be provided as selection menus, and when the user input a letter “p” after the letter “A”, “Application” and “April” may be provided as selection menus. Accordingly, the user can easily select a word which is wanted to be hyperlinked by the user through the selection menus.

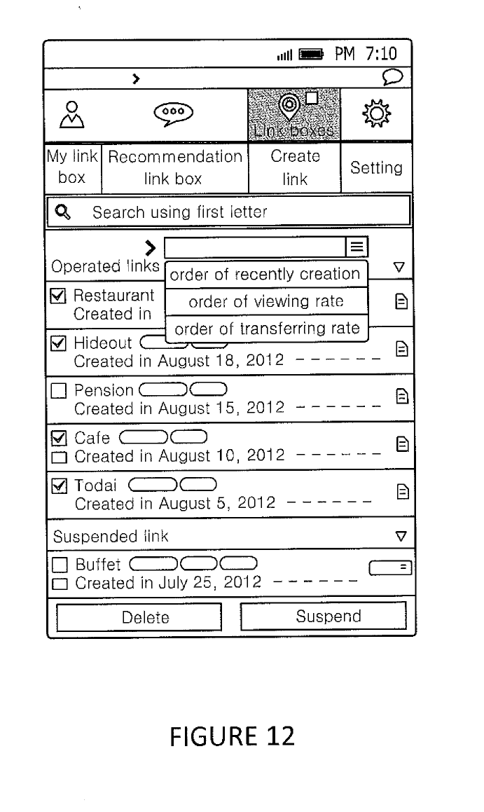

In this case, the hyperlink selecting unit 2130 sorts and displays words stored in the word storage unit 2110 according to a creation order, a rate at which or the number of times a text receiver clicks on a hyperlink for each word, a rate at which or the number of times each word is included in a text and transmitted, importance of related information related to each word, or the like. For example, as illustrated in FIG. 12, assuming that there are words, such as restaurant, hideout, pension, the hyperlink selecting unit 2130 may sort and display the words, according to a creation order, a viewing rate, a transferring rate, importance of an event related to each word, or the like, through an application installed in the mobile communication terminal 2100. FIG. 12 illustrates an example of providing user selection menus in a screen with respect to a generation order, a rate at which a receiver views each word, a rate at which each word is transmitted, a reward, or the like.

When a word stored in the word storage unit 2110 is input upon creation of a text, the related information linking unit 2140 may automatically hyperlink related information corresponding to the input word to the word. Alternatively, when a word stored in the word storage unit 2110 is input upon creation of a text, the related information linking unit 2140 may determine whether a hyperlink is selected by the hyperlink selecting unit 2130 with respect to the word, and when the hyperlink is selected through the hyperlink selecting unit 2130, hyperlink related information corresponding to the word to the word. In this case, when two or more pieces of related information are searched with respect to the same word, the related information linking unit 2140 may query a location of a target terminal, to which the text is transmitted, through a location query unit 2190 which is described below or may hyperlink related information selectively based on additional information, such as the gender, age of a user of the target terminal to which the text is transmitted.

The text transmitting unit 2150 transmits a text in the related information is hyperlinked to at least word by the related information linking unit 2140 to the receiver terminal 220 through the network 210.

The sharing setting unit 2160 sets whether to share the related information stored in the related information storage unit 2120. The sharing setting unit 2160 uploads the related information set to be shared to the sharing server 2200, thereby allowing other terminals to view the related information. That is, when sharing is set by the sharing setting unit 2160 with respect to at least one word, the mobile communication terminal 2100 uploads the related information stored in the related information storage unit 2120 and the word corresponding to the related information to the sharing server 2200, thereby allowing other terminals to download the related information corresponding to the word. In this case, the sharing setting unit 2160 may store information on whether specific related information is in a state of being shared by the sharing setting unit 2160 and display the information on the mobile communication terminal 2100. Also, the sharing setting unit 2160 may set whether to separately share a plurality of pieces of related information stored in the related information storage unit 2120 and, when two pieces of related information are present with respect to the same word, set whether to share the pieces of respective information differently from each other. Therefore, the user can share related information, which is provided by the user himself or herself upon creation of a text, with other persons according to words and related information.

The related information receiving unit 2170 accesses the related information sharing server 2200 through the network 210, and accesses related information that is shared by other persons. That is, the related information receiving unit 2170 may receive related information corresponding to the shared word from the related information sharing server 2200 and store the received related information in the related information storage unit 2120. Therefore, the user can easily update or register related information in his or her mobile communication terminal 2100 by using related information which the user only knows and related information shared between members. In this case, when a specific word is matched with word the shared related information, it is possible to allow the word to be automatically stored in the word storage unit 2110. Furthermore, the user may separately set or revise words stored in the word storage unit 2110 with respect to pieces of related information.

On the other hand, when a text received from another terminal is retransmitted to a third party terminal through the network 210, it is preferable that the text transmitting unit 2150 transmit the text in a state in which a hyperlinked word and its related information is shared. However, when related information for a specific word in the text received from the another terminal is set to be restrictively shared with the user's mobile communication terminal 2100, it is preferable that the related information for the word, which is to be retransmitted to the third party terminal, be set not to be shared and retransmitted.

The history storage unit 2180 stores history information including at least one of a transmission target, a transmission time, a hyperlinked word, and information on whether the related information corresponding to the hyperlinked word is shared, corresponding to the text transmitted to the network 210 by the text transmitting unit 2150. Therefore, the user can know which related information is provided with respect to which word in the text transmitted to the receiver terminal 220 and whether relevant related information is shared with the receiver terminal 220.

When two or more pieces of related information are searched from the related information storage unit 2120 corresponding to a selection made by the hyperlink selecting unit 2140, a location query unit 2190 queries for a location of the receiver terminal 220 which receives the text. In this case, the related information linking unit 2140 may hyperlink related information having the highest relevance degree based on the located queried by the location query unit 2190. In this case, the related information linking unit 2140 can select the related information having the highest relevance degree in consideration of receiver information including the gender, age, or the like of a receiver corresponding to the receiver terminal 220. The receiver information can be acquired with reference to an identification number corresponding to the receiver terminal 220.

As described above, the user directly sets related information for a specific word by using the mobile communication terminal, allows the related information by the user himself or herself to be hyperlinked in a text, and transmits the related information to another terminal, thereby allowing a receiver to easily access the specific related information and therefore, activating a social network.

Also, it is possible to activate a social network between users which share information by allowing specific related information set by the user to be shared with other persons to allow availability and accuracy of the related information to be verified between the users.

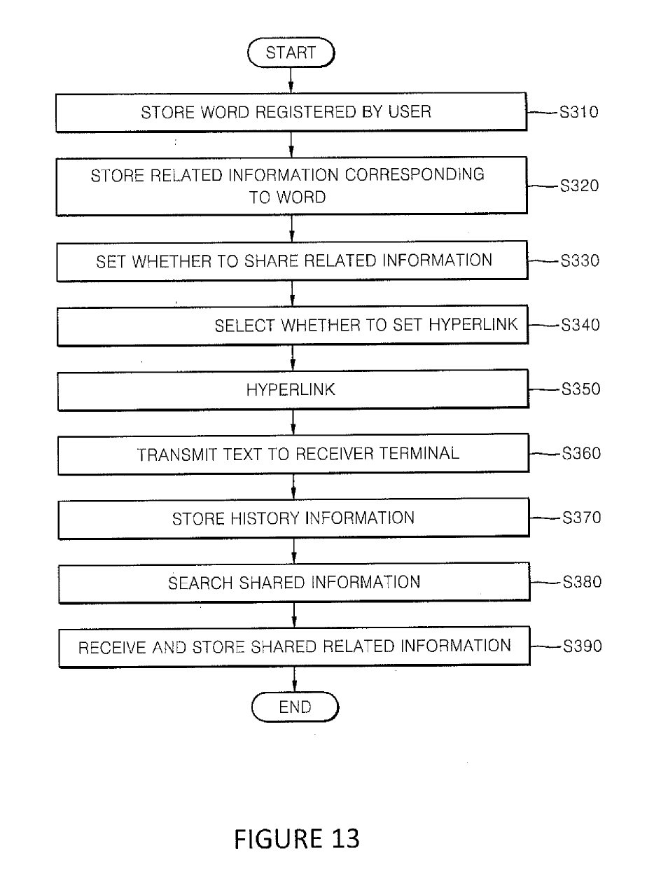

FIG. 13 is a flowchart illustrating a text transmission method for mobile communication terminals according to the second embodiment of the present invention. The text transmission method for mobile communication terminals may be performed by hardwires components of the mobile communication terminal 210 as well as by an application installed in the mobile communication terminal 2100.

The user can input and register a word to which the user wants to automatically or manually hyperlink related information upon creation of a text. The word storage unit 2110 stores the word registered by the user (S310), and the related information storage unit 2120 stores the related information corresponding to the word registered by the word storage unit 2110 (S320).

The sharing setting unit 2160 sets whether to share the related information stored in the related information storage unit 2120 (S330). In this case, the sharing setting unit 2160 uploads the related information set to be shared to the sharing server 2200 to allow other terminals to view the related information. Also, the sharing setting unit 2160 may display information on whether related information is shared by the sharing setting unit 2160 corresponding to the hyperlinked word. Also, the sharing setting unit 2160 may set whether to separately share a plurality of pieces of related information stored in the related information storage unit 2120 and, when two pieces of related information are present with respect to the same word, set whether to share the pieces of respective information differently from each other.

The hyperlink selecting unit 2130 selects whether to set a hyperlink to a word registered in the word storage unit 2110 (S340).

When two or more pieces of related information are searched from the related information storage unit 2120 corresponding to a selection made by the hyperlink selecting unit 2140, a location query unit 2190 queries for a location of the receiver terminal 220 which receives the text (S350).

The related information linking unit 2140 hyperlinks related information corresponding to the word from the related information storage unit 2120 according to a selection of the hyperlink selecting unit 2130. In this case, when two or more pieces of related information is searched from the related information storage unit 2120 corresponding to the word, the related information linking unit 2140 may hyperlink related information having the highest relevance degree based on a location queried by the location query unit 2190. That is, when two or more pieces of related information corresponding to a specific word are searched from the related information storage unit 2120 with respect to the text input by the user, the related information linking unit 2140 may hyperlink related information corresponding to a location closest to the receiver terminal 220 based on the location queried by the location query unit 2190. Also, when there are two or more pieces of related information corresponding to a predetermined range from the location of the receiver terminal 220, the related information linking unit 2140 may select related information having a high relevance degree in consideration of the receiver information including the gender, age, or the like of the receiver corresponding to the receiver terminal 220.

The text transmitting unit 2150 transmits a text in the related information is hyperlinked to at least word by the related information linking unit 2140 to the receiver terminal 220 through the network 210 (S370).

On the other hand, the sharing setting unit 2160 sets whether to share the related information stored in the related information storage unit 2120 according to a selection of the user. Therefore, it is possible to upload the related information set to be shared to the sharing server 2200 to enable other terminals to view the related information. In a state in which related information of various members is shared in the related information sharing server 2200, the mobile communication terminal 2100 accesses the related information sharing server 2200 and searches the shared related information (S380), and receives and stores related information wanted by the user of the searched related information (S390). The related information stored in the related information storage unit 2120 is stored to be matched with a specific word set by a sharer or a specific word newly set by the receiver of the related information.

The examples of the above-described first embodiment which are illustrated in FIGS. 3 to 7 are applicable similarly to the present embodiment, and therefore, a detailed description thereof will be omitted.

Furthermore, examples applicable to the first embodiment of the specific examples described in the second embodiment may be applied to the first embodiment in a similar manner. Also, examples applicable to the second embodiment of the specific examples described in the first embodiment may be applied to the second embodiment in a similar manner.

According to the embodiments of the present invention, when the mobile communication terminal transmits a SMS message, an email, or the like, related information previously set by the subscriber is automatically hyperlinked and transmitted to the receiver terminal, by merely creating a text. Therefore, the receiver can acquire the related information set by the subscriber without separate search.

Also, according to the present invention, the user can set and store a word of which related information is wanted to be transmitted by the user and set whether to share the related information. Another member which receives a relevant text can receive and store the related information waned by the member himself or herself, thereby allowing the member to easily acquire and set the related information.

Also, according to the present invention, the user can compare pieces of related information shared between members with respect to the same word and select optimal related information, thereby increasing reliability for the related information.

According to the present invention, when a SMS message, a text, or the like is created through the mobile communication terminal, related information can be transmitted through a simple operation of the user, thereby transmitting much information while reducing the number of inputs and an input time for the text.

Furthermore, the user directly sets related information for a specific word by using the mobile communication terminal, allows the related information by the user himself or herself to be hyperlinked in a text, and transmits the related information to another terminal, thereby allowing a receiver to easily access the specific related information.

Also, it is possible to activate a social network between users which share information by allowing specific related information set by the user to be shared with other persons to allow availability and accuracy of the related information to be verified between the users.

While the present invention has been described with respect to the specific embodiments, it will be apparent to those skilled in the art that various changes and modifications may be made without departing from the spirit and scope of the invention as defined in the following claims.

1. A related information providing apparatus for mobile communication terminals, the related information providing apparatus including related information in a text transmitted and received through a network to provide the related information, the related information providing apparatus comprising:
a related information storage unit that stores a word set by a subscriber and related information corresponding to the word;
a word searching unit that searches for the word stored in the related information storage unit from a text created by a mobile communication terminal connected to the related information providing apparatus through the network;
a related information linking unit that hyperlinks the related information stored in the related information storage unit to the word found by the word searching unit; and
a text transmitting unit that transmits the text to which the related information is hyperlinked by the related information linking unit, to the receiver terminal.

2. The related information providing apparatus for mobile communication terminals of claim 1, further comprising
a subscriber information storage unit that stores subscriber information including at least one of a name, an identification (ID), an email address, and a terminal identification number of the subscriber,
wherein the mobile communication terminal is a terminal of a subscriber of which subscriber information is stored in the subscriber information storage unit.

3. The related information providing apparatus for mobile communication terminals of claim 1, further comprising:
a selection signal receiving unit that receives a selection signal for the word which is hyperlinked by the related information linking unit, from the receiver terminal; and
a related information transmitting unit that transmits the related information stored in the related information storage unit to the receiver terminal corresponding to the selection signal received by the selection signal receiving unit.

4. The related information providing apparatus for mobile communication terminals of claim 3, wherein the related information transmitting unit transmits a selection menu for selecting a detailed item included in the related information of the hyperlinked word to the receiver terminal.

5. The related information providing apparatus for mobile communication terminals of claim 1, further comprising a history storage unit that stores history information including transmission records of the hyperlinked word in the text transmitted to the receiver terminal by the text transmitting unit.

6. The related information providing apparatus for mobile communication terminals of claim 5, wherein the related information transmitting unit transmits the history information to at least one of the mobile communication terminal and the receiver terminal.

7. The related information providing apparatus for mobile communication terminals of claim 1, further comprising a receiver information storage unit that stores receiver information including at least one of a name, an identification (ID), an email address, and a terminal identification number of a receiver,
wherein the related information linking unit hyperlinks relevant related information to a word searched by the word searching unit when the receiver terminal is a receiver terminal of a receiver stored in the receiver information storage unit.

8. The related information providing apparatus for mobile communication terminals of claim 1, wherein, when two or more pieces of related information are searched with respect to the same word, the related information linking unit hyperlinks relevant information corresponding to a location of the receiver terminal.

9. The related information providing apparatus for mobile communication terminals of claim 1, wherein, when an instruction for retransmitting the text received by the receiver terminal to a third party terminal is received from the receiver terminal, the text transmitting unit retransmits a text that is hyperlinked similarly as the text transmitted to the receiver terminal, to the third party terminal.

10. The related information providing apparatus for mobile communication terminals of claim 1, further comprising a receiver information storage unit that stores receiver information including at least one of a name, an identification (ID), an email address, and a terminal identification number of a receiver,
wherein the related information storage unit stores related information corresponding to a receiver stored in the receiver information storage unit.

11. A related information system for mobile communication terminals, comprising:
a mobile communication terminal that creates a text, stores related information for at least one in the text, hyperlinks the related information to the word, and transmits the text including the hyperlinked word through a network;
a receiver terminal that receives the text from the mobile communication terminal; and
a related information sharing server that stores related information that is set to be shared from among the related information stored in the mobile communication terminal and, when a request for receiving the related information set to be shared is provided from the mobile communication terminal, transmits the related information to the mobile communication terminal.

12. A mobile communication terminal which creates a text and transmits the created text through a network, comprising:
a word storage unit that stores a word registered by a user;
a related information storage unit that stores related information corresponding to the word registered in the word storage unit;
a related information linking unit that, when the word stored in the word storage unit is input upon creation of the text, hyperlinks related information corresponding to the input word; and
a text transmitting unit that transmits the text, in which related information is hyperlinked to at least one word by the related information linking unit, through a network.

13. The mobile communication terminal of claim 12, further comprising a hyperlink selecting unit that, when the word stored in the word storage unit upon creation of the text, selecting whether to set a hyperlink of the related information corresponding to the input word,
wherein the related information linking unit hyperlinks relevant related information when the hyperlink is selected by the hyperlink selecting unit.

14. The mobile communication terminal of claim 12, further comprising a sharing setting unit that sets whether to share the related information stored in the related information storage unit and uploads the related information set to be shared to a related information sharing server through a network.

15. The mobile communication terminal of claim 12, further comprising a history information storage unit that stores history information including at least one of a transmission target, a transmission time, a hyperlinked word, and information on whether the related information, corresponding to the text transmitted to the network by the text transmitting unit.

16. The mobile communication terminal of claim 12, further comprising a location query unit that queries for a location of a transmission target when two or more pieces of related information are searched from the related information storage unit corresponding to a selection by the hyperlink selection unit,
wherein the related information linking unit hyperlinks related information corresponding to the location queried by the location query unit.
